(19) United States
(12) Patent Application Publication
(10) Pub. No.: US 2015/0363421 A1
(43) Pub. Date: Dec. 17, 2015

(54) DIRECTORIES IN DISTRIBUTED FILE SYSTEMS

(71) Applicant: Yahoo! Inc., Sunnyvale, CA (US)

(72) Inventor: Edward Bortnikov, Haifa (IL)

(21) Appl. No.: 14/301,834

(22) Filed: Jun. 11, 2014

(51) Int. Cl. G06F 17/30

(52) U.S. Cl. CPC G06F 17/30174; G06F 17/30215

(57) ABSTRACT

Briefly, embodiments of methods and/or systems of providing services in a distributed file system are disclosed. For one embodiment, as an example, a system may be capable of forming server-side mount tables comprising hierarchically organized namespaces. Server-side mount tables may be replicated or reproduced across services platforms, for example.

### BACKGROUND

1. Field

The present disclosure relates generally to distributed systems, such as those employing services for locating content, for example.

2. Information

When using an Internet search engine, for example, it is generally desirable for comprehensive search query results to be returned in a timely manner. To bring about a capability for providing timely Internet search results, an Internet search engine provider, for example, may conduct a web crawling function as an off line and/or background process, which may be performed well in advance of receiving search queries. A web crawling function may provide indices of perhaps hundreds of millions or even billions of documents that may permit a search engine to provide relevant search results in a fraction of a second, for example.

In some instances, a web crawler may operate to access electronic documents from various locations of a network, such as the Internet, and may add accessed documents to a document collection. Responsive to addition of electronic documents to a collection, a web services platform (SP) may operate to index electronic documents and to construct new documents, for example, which may be internally organized to permit keyword searching. In many instances, a web crawler and an SP may perform extensive read and/or write operations, for example, to a document collection during construction of new documents.

Accordingly, at times, one or more SPs may become excessively burdened, such as from analyzing a vast number of electronic documents so that indexing, such as metadata indexing of keywords, for example, may be performed. Thus, providing such services may represent a bottleneck that contributes to delays and increased consumption of processing resources to bring about performing web crawling and/or indexing operations.

### BRIEF DESCRIPTION OF DRAWINGS

Claimed subject matter is particularly pointed and/or distinctly claimed in the concluding portion of the specification. However, both as to organization and/or method of operation, together with objects, features, and/or advantages thereof, claimed subject matter may be understood by reference to the following detailed description if read with the accompanying drawings in which:

FIG. 1 is a schematic diagram of a computing environment in which a services platform may operate according to an embodiment;

FIG. 2 is a schematic diagram of a hierarchically organized server-side mount table and service platform hosting files according to an embodiment;

FIG. 3 is a schematic diagram showing migration of storage among service platforms according to an embodiment; and

FIG. 4 is a schematic diagram of a computing platform that may be employed according to an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. For purposes of explanation, specific numbers, systems, and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes, and/or equivalents may occur to those skilled in the art. It is, therefore, to be understood that appended claims are intended to cover any and all modifications and/or changes as fall within claimed subject matter.

Reference throughout this specification to “one implementation,” “an implementation,” “one embodiment,” “an embodiment” and/or the like may mean that a particular feature, structure, and/or characteristic described in connection with a particular implementation and/or embodiment may be included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described may be combined in various ways in one or more implementations. In general, of course, these and other issues may vary with context. Therefore, particular context of description and/or usage may provide helpful guidance regarding inferences to be drawn.

Operations and/or processing, such as in association with networks, such as communication networks, for example, may involve physical manipulations of physical quantities. Typically, although not necessarily, these quantities may take the form of signals and/or states, such as magnetic and/or electrical signals, for example, capable of, for example, being stored, transferred, combined, processed, compared, and/or otherwise manipulated. It has proven convenient, at times, principally for reasons of common usage, to refer to these signals as bits, data, values, elements, symbols, characters, terms, numbers, numerals, and/or the like. It should be understood, however, that all of these and/or similar terms are to be associated with appropriate physical quantities and are intended to merely be convenient labels.

In this context, the terms “coupled,” “connected,” and/or similar terms, may be used. It should be understood that these terms are not intended as synonyms. Rather, “connected” may be used to indicate that two or more elements and/or other components, for example, are in direct physical and/or electrical contact; while, “coupled” may mean that two or more components are in direct physical, including electrical contact; however, “coupled” may also mean that two or more components are not in direct contact, but may nonetheless co-operate and/or interact. The term “coupled” may also be understood to mean indirectly connected, for example, in an appropriate context.

The terms, “and,” “or,” “and/or,” and/or similar terms, as used herein, may include a variety of meanings that also are expected to depend at least in part upon the particular context in which such terms are used. Typically, “or” if used to associate a list, such as A, B, or C, is intended to mean A, B, and C, here used in the inclusive sense, as well as A, B, or C, here used in the exclusive sense. In addition, the term “one or more” and/or similar terms may be used to describe any feature, structure, and/or characteristic in the singular and/or may be used to describe a plurality or some other combination of features, structures and/or characteristics. In this context, the term “between” and/or similar terms are understood to include “among” if appropriate for the particular usage. Likewise, in this context, the terms “compatible with,” “comply with” and/or similar terms are understood to include substantial compliance and/or substantial compatibility. Though it should be noted that these are merely illustrative examples and claimed subject matter is not limited to this example.

The term “network device” may refer to any device capable of communicating via and/or as part of a network. Network devices may be capable of sending and/or receiving signals (e.g., signal packets), such as via a wired and/or wireless network, may be capable of performing arithmetic and/or logic operations, processing and/or storing signals, such as in memory as physical memory states, and/or may, for example, operate as a server. Network devices capable of operating as a server, or otherwise, may include, as examples, dedicated rack-mounted servers, desktop computers, laptop computers, set top boxes, tablets, netbooks, smart phones, integrated devices combining two or more features of the foregoing devices, the like or any combination thereof.

It should be understood that for ease of description, a network device may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

A network may comprise two or more network devices and/or may couple network devices so that signal communications, such as in the form of signal packets, for example, may be exchanged, such as between a server and a client device and/or other types of network devices, including between wireless devices coupled via a wireless network, for example. It is noted that the terms, server, server device, server computing device, server computing platform, and/or similar terms are used interchangeably. While in some instances, for ease of description, these terms may be used in the singular, such as by referring to a “client device,” “client computing device,” “server device,” or a “services platform,” the description is intended to encompass one or more client devices, and/or one or more server devices/platforms, as appropriate. Along similar lines, references to a “database” are understood to mean, one or more databases and/or portions thereof, as appropriate. It is noted that terms, such as “operation”, function,” and/or the like may be used interchangeably in this context.

A network may also include now known, and/or to be later developed arrangements, derivatives, and/or improvements, including, for example, past, present and/or future mass storage, such as network attached storage (NAS), a storage area network (SAN), and/or other forms of computer and/or machine readable media, for example. A network may include the Internet, one or more local area networks (LANs), one or more wide area networks (WANs), wire-line type connections, wireless type connections, other connections, and/or any combination thereof. Thus, a network may be worldwide in scope and/or extent. Likewise, sub-networks, such as may employ differing architectures, including being compliant and/or compatible with differing protocols, such as communication protocols (e.g., network communication protocols), may interoperate within a larger network. Various types of devices may be made available so that device interoperability is enabled and/or, in at least some instances, may be transparent to the devices. In this context, the term transparent refers to communicating in a manner so that communications may pass through intermediaries, but without the communications necessarily specifying one or more intermediaries, such as intermediate devices, and/or may include communicating as if intermediaries, such as intermediate devices, are not necessarily involved. For example, a router may provide a link between otherwise separate and/or independent LANs. In this context, a private network refers to a particular, limited set of network devices able to communicate with other network devices in the particular, limited set, such as via signal packet transmissions, for example, without a need for re-routing and/or redirecting such communications. A private network may comprise a stand-alone network; however, a private network may also comprise a subset of a larger network, such as, for example, without limitation, the Internet. Thus, for example, a private network “in the cloud” may refer to a private network that comprises a subset of the Internet, for example. Although signal packet transmissions may employ intermediate devices to exchange signal packet transmissions, those intermediate devices may not necessarily be included in the private network by not being a source or destination for one or more signal packet transmissions, for example. As another example, a logical broadcast domain may comprise an example of a private network. It is understood in this context that a private network may provide outgoing communications to devices not in the private network, but such devices outside the private network may not direct inbound communications to devices included in the private network.

The Internet refers to a decentralized global network of interoperable networks, including devices that are part of those interoperable networks. The Internet includes local area networks (LANs), wide area networks (WANs), wireless networks, and/or long-haul public networks that, for example, may allow signal packets to be communicated between LANs. The term world wide web (WWW) and/or similar terms may also be used to refer to the Internet. Signal packets, also referred to as signal packet transmissions, may be communicated between nodes of a network, where a node may comprise one or more network devices, for example. As an illustrative example, but without limitation, a node may comprise one or more sites employing a local network address. Likewise, a device, such as a network device, may be associated with that node. A signal packet may, for example, be communicated via a communication channel and/or a communication path comprising the Internet, from a site via an access node coupled to the Internet. Likewise, a signal packet may be forwarded via network nodes to a target site coupled to a local network, for example. A signal packet communicated via the Internet, for example, may be routed via a path comprising one or more gateways, servers, etc. that may, for example, route a signal packet in accordance with a target address and availability of a network path of network nodes to a target address.

Physically connecting portions of a network via a hardware bridge, as one example, may be done, although other approaches also exist. A hardware bridge, however, may not typically include a capability of interoperability via higher levels of a network protocol. A network protocol refers to a set of signaling conventions for communications between and/or among devices in a network, typically network devices, but may include computing devices, as previously discussed; for example, devices that substantially comply with the protocol and/or that are substantially compatible with the protocol. Typically, a network protocol has several layers. These layers may be referred to here as a communication stack. Various types of communications may occur across various layers. For example, as one moves higher in a communication stack, additional functions may be available by transmitting communications that are compatible and/or compliant with a particular network protocol at these higher layers. A network may be very large, such as comprising thousands of nodes, millions of nodes, billions of nodes, or more, as examples.

Media networks, such as the Yahoo!™ network, for example, may be increasingly seeking ways to attract users to their networks and/or to retain users within their networks for extended periods of time. A media network may, for example, comprise an Internet website and/or group of websites having one or more sections. For instance, the Yahoo!™ network includes websites located within different categorized sections, such as sports, finance, current events, and games, to name just a few non-limiting examples among a variety of possible examples. To attract and/or retain users within its network, Yahoo!™ and/or other media networks may continually strive to provide content relating to categorized sections that may be interesting and/or of use to users.

As more users remain within a media network for extended periods of time, a media network may become more valuable to potential advertisers. Thus, typically, advertisers may be inclined to pay more money and/or provide other considerations to a media network in return for advertising to users, for example, via that media network, its partners, and/or subsidiaries. In an implementation, if a user displays a page, perhaps as a result of utilizing a search engine, a server, as an example, located within or external to a processing and/or communications infrastructure of a media network may deliver relevant content, which may include, for example, textual and/or multimedia content that may entice users to remain for a relatively extended period of time.

As a non-limiting example, responsive to submitting a search query (e.g., terms that may be submitted to a search engine) for example, and/or as a result of any other type of interaction with a client computing platform, for example, such as via a browser, a user may access one or more pages (e.g., web pages), for example. Search query results and/or query suggestions that may be beneficial to a user in conducting further search operations may be delivered to a client computing device, such as for presentation to a user, by way of display device coupled to a client computing device. Search results and/or search query suggestions, for example, may be arranged, at least in some instances, in decreasing order of relevance as determined and/or estimated by search query processing operations. Presentation of search results, such as in decreasing order of relevance (e.g., more relevant search results displayed near a top portion of a search results page), as a non-limiting example, may permit a user of a client computing device to more efficiently access one or more electronically stored documents, for example, that may be reasonably pertinent to a user's search query. In some instances, especially if a user is frequently interacting with a search engine to perform research, for example, a user may place particular importance on obtaining timely search results responsive to submitting search queries. In the event that search tools appear and/or are unresponsive, a user may suspend use of a particular search tool and attempt use of a different search tool, for example. Thus, again, providing timely, relevant, and/or organized search results is desirable in general.

As the term may be used herein, an “electronic document” or an “electronically stored document,” such as may be returned from a search engine, including as a hyperlink, for example, as a response to submittal of a search query for example, may comprise any type of human- and/or machine-readable material. For example, a human readable electronic document may comprise content, such as magazine, journal, and/or newspaper articles, accessible from storage, such as online and/network storage, including a local network for example. As one non-limiting example written content may be stored using and/or as a Portable Document Format (PDF), just to name an example. A human readable electronic document may likewise comprise one or more portions of an audio file; one or more portions of a video file such as a still image, a video “clip,” and so forth; a novel, textbook, or any other form of literature. An electronic document may also comprise stored machine-readable materials, such as UPC codes, QR codes, or other materials comprising symbols that may not be intelligible by a human. It should be noted that claimed subject matter is intended to embrace all types of electronic documents, which may be represented using arrangements of binary digits capable of storage using transformations of physical states, such as memory states, for example.

In some embodiments, a large corpus of content, such as electronic documents, which may number in the hundreds of millions, billions, virtually without limitation, may be stored across a vast network of devices, including memory devices capable of being accessed by computing devices. In such a network, which may be referred to as a “distributed system” (e.g., a Hadoop distributed computing system), a processing node may represent a cluster of computing and/or storage devices, although claimed subject matter is not limited in scope in this respect. Processing nodes may be organized into processing clusters and/or processing groups comprising any number of individual computing devices, such as a single device, a collection of several computing devices, or perhaps many hundreds, thousands, or greater number of individual computing devices. Claimed subject matter is intended to embrace the vast variety of possible distributed computing structures.

Also as used herein, one or more parameters of content, wherein content includes one or more electronic documents, refer to physical signals and/or states, such as memory states, that are descriptive of features associated with particular content. For example, one or more parameters referring to an electronic document comprising a photographic image may include parameters, such as time of day at which a photographic image was taken, latitude and longitude of an image capture device, such as a camera, for example. In another example, one or more parameters relevant to content comprising a technical article may include one or more authors, for example. Claimed subject matter is intended to embrace meaningful, descriptive parameters in any format, so long as the one or more parameters comprise physical signals and/or states, which may include, as parameter examples, technique of creation of an electronic document, purpose of an electronic document, time and date of creation of an electronic document, logical path of an electronic document (or portion thereof), encoding formats and/or standards used for encoding an electronic document, and so forth.

In one or more embodiments, responsive to receipt of a user query from a client device, for example, a service may be utilized to provide logical paths for parameters, such as a universal resource locator (URL), as an example, which may enable a client device to access content, such as electronic documents, for example, and/or portions thereof. A path for a parameter, such as a logical path, may refer to a logical path for a component of a specific network resource of a host computing and/or storage device at which electronic documents may be stored and/or otherwise made accessible, such as particular memory locations, for example. According to some embodiments, parameters for content, also referred to as content related parameters, may be made accessible along with providing other additional services. Claimed subject matter is not limited to a service providing logical paths for parameters associated with content, such as electronic documents.

In particular embodiments, organizing content related parameters substantially according to a hierarchical file structure, for example, may enable parameters to be distributed among several service platforms (SPs) for a distributed system. In various embodiments, as described in more detail below, distributing storage of parameters among, for example, several SPs may reduce processing burdens on individual SPs.

Accordingly, for one or more embodiments, responsive to distributing content related parameters, as previously described, among, for example, 5 SPs, 10 SPs, or any other number of SPs, access speed to content associated with the parameters may be increased, again, described in more detail below. Additionally, for one or more embodiments, by replicating a hierarchically organized directory of content related parameters among many SPs queries, such as requests for a logical path of parameters for content matching search criteria, for example, may involve no more than a single redirection from a first SP to a second SP. Further, at least in some embodiments, content related parameters may be load balanced, which may enable processing, such as of content related parameters, may be more evenly allocated among SPs so that access speed may be maintained even during times of peak demand for access. Organization of content related parameters into hierarchical file structures may bring about other benefits, and claimed subject matter is not limited in this respect.

In one or more embodiments, a “namespace” may refer to a hierarchically organized directory comprising subdirectories, subtrees, and/or descriptors for one or more parameter files, for example, such as content related parameters. Within a namespace, portions of a hierarchically organized directory, such as subdirectories, subtrees, and so forth, may be detached from a first location of the namespace and attached to a second location of the namespace, illustrated below by a non-limiting example. Responsive to modification of a hierarchically organized directory, a modified directory may be replicated or reproduced across a plurality of SPs. Detachment and reattachment of subdirectories, subtrees, and so forth within a namespace may permit renaming of directory entries without migration of parameters among SPs and without involving migration of associated content from computing and/or file storage devices of a distributed system, for example. Detachment and reattachment of portions of a hierarchically organized directory may bring about other benefits, and claimed subject matter is not limited to benefits such as may be associated with one or more specific embodiments.

One or more embodiments, for example, may overcome drawbacks of typical approaches of a data-type service associated with a distributed system. For example, typical services provisioning schemes may involve hosting pertinent content related parameters in a random access memory of a single computing entity. Although such an approach may enable timely service of parameters responsive to queries, such as from computing devices, the sheer volume/number of parameters may easily exceed memory limits of individual computing devices. Another approach may involve pre-partitioning and/or dynamic repartitioning of parameters, without, for example, use of hierarchically organized metadata directories, lookup tables, etc. Although such partitioning and/or repartitioning may be employed, maintaining consistency and/or synchronization, such as with respect to content related parameters and associated content may be problematic.

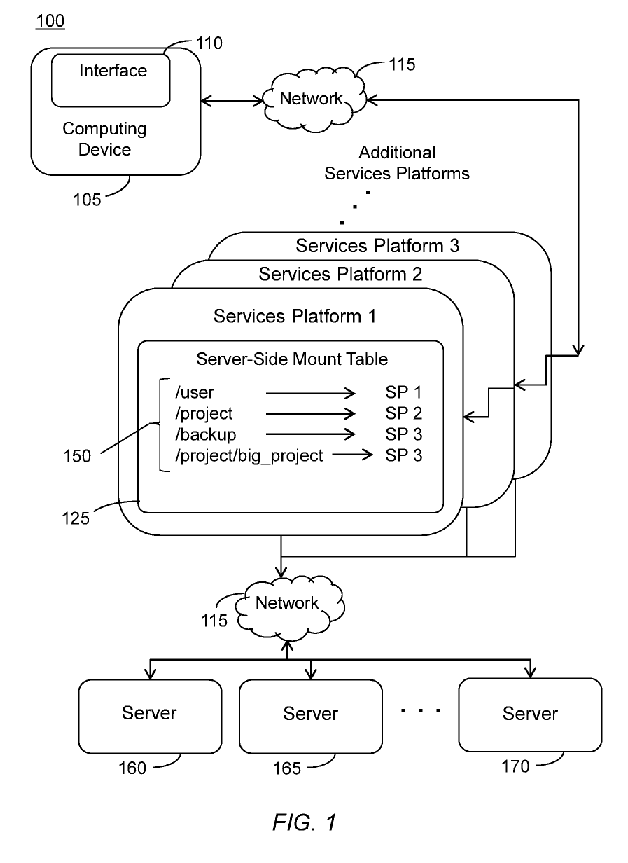

FIG. 1 is a schematic diagram 100 of a computing environment in which a services platform, such as for content related parameters, may operate according to an embodiment. In FIG. 1, computing device 105 represents a client computing device, which may be operated by one or more individual human users by way of an interface 110. For example, a user may interact with interface 110 to formulate a search query to obtain content, such as one or more relevant documents stored by, or at least made accessible via, one or more of servers 160, 165, and/or 170. In another example, computing device 105 may receive commands from interface 110 in a manner that permits autonomous, non-human users to interact with client computing device 105 to request services, such as metadata services, for example. It should be noted that user interface 110 may accommodate both human and non-human users, perhaps simultaneously, and claimed subject matter is not limited in this respect.

In response to receipt of a services request transmitted from client computing device 105 through a network 110, one or more of SPs 1, 2, and 3,may perform a read and/or write operation on one or more electronic documents stored within, or accessible to, server 160, server 165, and/or server 170. In one possible example, client computing device 105 may specify a document identifier, such as a universal resource locator, and a specification of an operation to be performed on an electronic document. In some embodiments, requested operations may comprise locating a particular computing device such as one or more of server 160, 165, and 170, at which a particular electronic document may be found. In another possible example, client computing device may identify one or more parameters to be added, for example, to one or more electronic documents located at a particular computing device. As part of servicing a request from client computing device 105, one or more of SPs 1, 2, and 3, wherein 1, 2, and 3 represent examples of SP identifiers, to obtain logical paths for parameters specifying locations of relevant electronic documents, for example. Although only three SPs are illustrated in FIG. 1, additional SPs, which may number into the dozens, hundreds, and so forth, may be utilized to provide logical paths, such as URLs, to client computing device 105, for example. In effect, logical paths operate similar to memory pointers, such as may be employed in memory and similar types of technologies, e.g., databases, etc. Client computing device 105 may utilize network 115 to interact with additional computing platforms not shown in FIG. 1, and claimed subject matter is not limited in this respect.

Particular embodiments avoid shortcomings of typical servicing systems, such as metadata servicing systems, by locating directory parameters by utilizing one or more of SPs 1, 2, and 3 to store or otherwise have access to server-side mount table 125. In one or more embodiments, a server-side mount table 125 may be replicated or reproduced across all SPs, or at least across a considerable number of SPs, such as those shown in FIG. 1, thus avoiding difficulties brought about by incomplete or out of date client-side mount tables, such as mount tables that may be stored at numerous client devices (e.g., client device 105). Further, particular embodiments avoid difficulties brought about by using file systems, such as UNIX file systems, that may be incapable of operating efficiently in the event of non-uniform and/or uneven growth of a file system.

In the embodiment of FIG. 1, for example, server-side mount table 125 provides a hierarchically organized directory comprising one or more namespaces 150 and a SP, which may store, or otherwise have access to, content related parameters. In one or more embodiments, content related parameters may comprise one or more of a top-level domain, subdomain, folder/path, page, named anchor, and so forth. Thus, for the embodiment of FIG. 1, SPs 1, 2, and 3 provide parameters to computing device 105, which may permit client computing device 105 to access, content, such as documents stored at or at least made accessible by one or more of servers 160, 165, and 170. It should be noted that although only three servers are shown in FIG. 1, embodiments involving distributed file systems, such as Hadoop, for example, may involve hundreds, thousands, or a greater number of servers.

In FIG. 1, the high-level or mounted subtree root directory “/user” may correspond to stored parameters, such as content related parameters, which may be descriptive of electronically-generated content corresponding to individual users of a particular distributed computing system, for example, and may be stored at SP 1, for example. Accordingly, in this illustrative example, a user of client computing device 110 seeking access to content generated by a particular user, for example, may transmit a request to any one or more of SPs 1, 2, and 3. SPs receiving a request, for example, may access server-side mount table 125, which may be replicated or reproduced across SPs, and may redirect the received request to SP 1. Likewise, SPs receiving a request for parameters corresponding to content relevant to the high-level or mounted subtree root directory “/project” may redirect the received request to SP 2. Likewise, SPs receiving a request for parameters corresponding to content relevant to the high-level or mounted subtree root directory “/backup” or relevant to subdirectory “/project/big_project” may redirect the received request to SP 3.

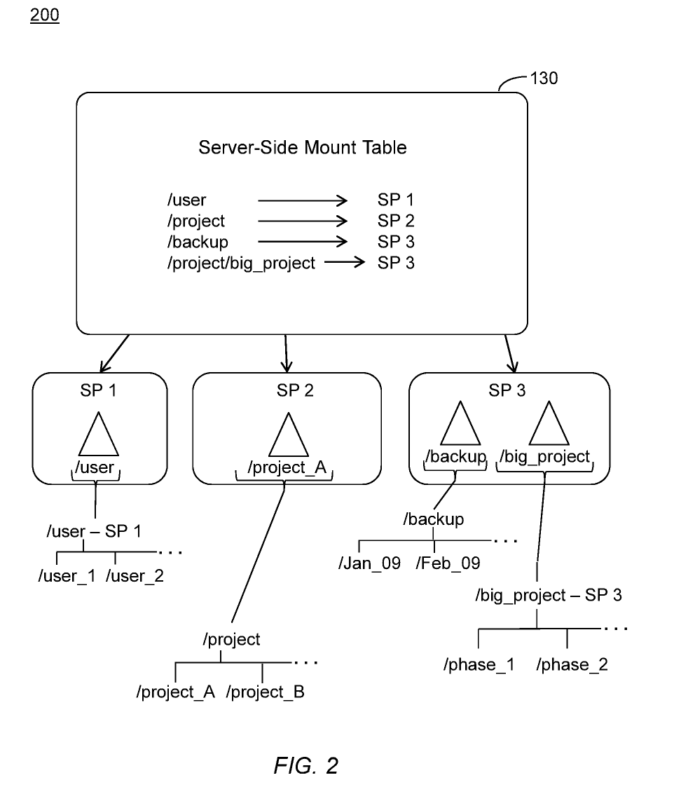

FIG. 2 is a schematic diagram 200 of a hierarchically organized server-side mount table and SPs hosting stored parameters according to an embodiment. In this context, a server-side mount table refers to any type of organized arrangement, such as a hierarchically organized directory, which provides logical location, such as a logical memory, including for example, logical addresses of individual servers, at which content, such as individual electronic documents, are accessible. In the example of FIG. 2, server-side mount table 130 comprises the three high-level or mounted subtree root directories “/project,” “/user,” and “/backup.” Parameters for content relevant to subdirectory “/user,” such as “/user_{—}1” and “/user_{—}2,” may be hosted by SP 1. Likewise, parameters for content relevant to the high-level or mounted subtree root “/backup,” such as monthly backups “/Jan_{—}09,” “/Feb_{—}09,” and so forth, may be hosted by SP 3. Of course, this illustrative example is greatly simplified for convenience of discussion; real-world implementations of server-side mount tables may comprise many more subdirectories and/or descriptors for stored parameters, often as files, such as dozens, hundreds, and so forth.

In the example of FIG. 2, parameters relevant to the high-level or mounted subtree root directory “/project,” which may comprise “/project_A,” and “/project_B,” etc., may be hosted by SP 2. Parameters relevant to the high-level or mounted subtree root directory “/big_project,” which may represent a subdirectory of “/project,” may be hosted, for example, by SP 3. Accordingly, in the embodiment of FIG. 2, parameters for projects within the high-level or mounted subtree root directory “/project” may be divided or partitioned among differing SPs. Thus, for example, parameters for content relevant to projects other than “/big_project” may be hosted by SP 2, whereas parameters for content relevant to “/big_project” may be hosted by SP 3.

In FIG. 2, for this particular embodiment, high-level or mounted subtree root directories, such as “/user,” “/backup,” and “/project,” for example, may be associated with nodes of a subdirectory having the longest path to a root directory. For example, in this particular illustration, content relevant to “project/project_A” and “project/project_B” belong to the subdirectory “/project,” which may be hosted by SP 2. In contrast, content relevant to “/phase_{—}1” may belong to the subdirectory “/big_project,” which may be hosted by SP 3.

FIG. 2 further illustrates that subdirectories of a server-side mount table may be moved and/or renamed within a namespace without necessarily migrating stored parameters among SPs. For example, in FIG. 2, the subdirectory “/big_project/phase_{—}1” may be ‘detached’ from the “/project” node and ‘reattached’ as a subdirectory of “/user,” beneath the node “/user,” to form “/user/big_project/phase_{—}1.” However, for example, although the subdirectory “/big_project/phase_{—}1” may represent a newly created subdirectory of “/user,” content relevant to “/big_project/phase_{—}1” may remain as hosted by SP 3. Updates to server-side mount tables, which may result from movement and/or renaming within the namespace may be replicated across all SPs, in an embodiment, for example.

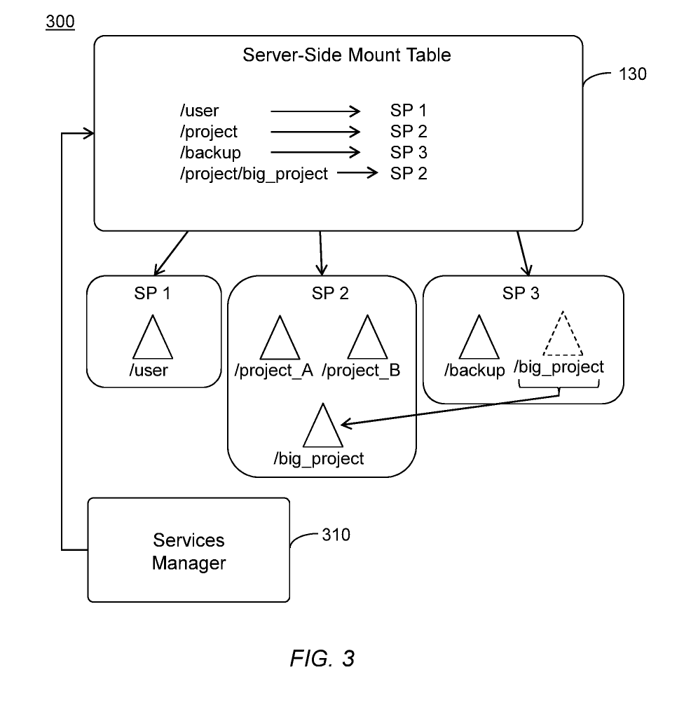

FIG. 3 is a schematic diagram 300 showing migration of parameter storage among SPs according to an embodiment. In FIG. 3, parameters relevant to “/big_project,” which is shown in FIG. 2 as being hosted by SP 3, is illustrated as migrating to SP 3, for example. In one or more embodiments, migration of parameters among SPs may take place in response to determining desirability of rebalancing among services platforms, for example. In one possible example, if SP 3 experiences an unusually large number of queries to obtain parameters for content relevant to subdirectory “/backup” and “/big_project,” parameters relevant to “/big_project” may be migrated from SP 3 to SP 2.

In certain embodiments, for example, migration, which may involve detaching of one or more subdirectories (e.g., “subtrees”) from a first location, such as of a server-side mount table and/or of a first platform, for example, and reattaching the one or more subdirectories to a second location, such as of a server-side mount table and/or of a second platform, need not necessarily involve movement of electronically stored content, such as electronic documents stored on one or more of servers 160, 165, and 170, for example. Accordingly, in the example of FIG. 3, although parameters relevant to “/big_project” may be shown as migrating from SP3 to SP2, platform identifiers within directory “/big_project” may be preserved. Thus, subdirectories, for example, of “/big_project” continue to provide accurate parameters, including logical addresses, for example, for servers at which electronic documents are stored, in this example.

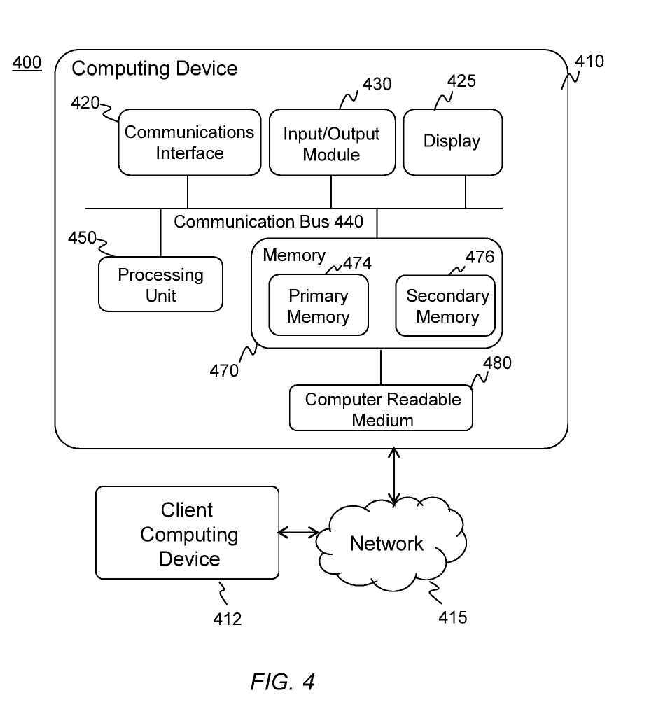

For purposes of illustration, FIG. 4 is a schematic diagram 400 of a computing platform that may be employed for hierarchically organizing a namespace in a distributed system according to an embodiment. A computing platform, such as that embodied in FIG. 4 may comprise computing device 410 that may be employed to perform operations such as, for example, described herein. In FIG. 4, computing device 410 may represent a computing device capable of operating within a Hadoop and/or similar distributed computing framework. Computing device 410 may interface with client device 412, which may comprise features of a cellular telephone, a smart phone, a personal digital assistant, a wearable computer, a wrist phone, a laptop computer, a personal entertainment system, a tablet personal computer, a personal audio and/or video device, a personal navigation device, as well as other types of client devices, for example.

Communications interface 420, processor 450, and memory 470, which may comprise primary memory 474 and secondary memory 476, may communicate by way of communication bus 440, for example. In FIG. 4, computing device 410 may store various forms of computer-implementable instructions, by way of input/output module 430, for example, such as those that may be operative, for example, to provide metadata services, such as metadata path parameters which may specify a location of one or more electronic documents. Client device 412 may communicate with computing device 410 by way of a wired and/or wireless Internet connection via network 415, for example. Although a computing platform, such as the computing platform embodied in FIG. 4 shows the above-identified components, claimed subject matter is not limited to computing platforms having only these components as other implementations may include alternative arrangements that may comprise additional components, fewer components, or components that function differently while achieving similar results. Rather, examples are provided merely as illustrations. It is not intended that claimed subject matter be limited in scope to illustrative examples.

Processor 450 may be representative of one or more circuits, such as digital circuits, to perform at least a portion of a computing procedure and/or process. By way of example but not limitation, processor 450 may comprise one or more processors, such as controllers, microprocessors, microcontrollers, application specific integrated circuits, digital signal processors, programmable logic devices, field programmable gate arrays, and the like, or any combination thereof. In implementations, processor 450 may perform signal processing to manipulate signals and/or states and/or to construct signals and/or states, for example.

Memory 470 may be representative of any storage mechanism. Memory 470 may comprise, for example, primary memory 474 and secondary memory 476, additional memory circuits, mechanisms, or combinations thereof may be used. Memory 470 may comprise, for example, random access memory, read only memory, or one or more data storage devices and/or systems, such as, for example, a disk drive, an optical disc drive, a tape drive, a solid-state memory drive, just to name a few examples. Memory 470 may be utilized to store a program, as an example. Memory 470 may also comprise a memory controller for accessing computer-readable medium 480, which may providing metadata services such as metadata path parameters responsive to one or more received search terms. Under direction of processor 450, memory, such as cells storing physical states, representing, for example, a program, may be executed by processor 450 and generated signals may be transmitted via the Internet, for example. Processor 450 may also receive digitally encoded signals from computing device 410.

Network 415 may comprise one or more communication links, processes, and/or resources to support exchanging communication signals between a client computing device and server, which may, for example, comprise one or more servers (not shown). By way of example, but not limitation, network 415 may comprise wireless and/or wired communication links, telephone or telecommunications systems, Wi-Fi networks, Wi-MAX networks, the Internet, the web, a local area network (LAN), a wide area network (WAN), or any combination thereof.

The term “computing platform,” as used herein, refers to a system and/or a device, such as a computing device, that includes a capability to process and/or store data in the form of signals and/or states. Thus, a computing platform, in this context, may comprise hardware, software, firmware, or any combination thereof (other than software per se). Computing device 410, as depicted in FIG. 4, is merely one such example, and claimed subject matter is not limited to this particular example. For one or more embodiments, a computing platform may comprise any of a wide range of digital electronic devices, including, but not limited to, personal desktop or notebook computers, high-definition televisions, digital versatile disc (DVD) players and/or recorders, game consoles, satellite television receivers, cellular telephones, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 470 may store cookies relating to one or more users and may also comprise a computer-readable medium that may carry and/or make accessible content, code and/or instructions, for example, executable by processor 450 or some other controller or processor capable of executing instructions, for example. A user may make use of an input device and/or an output device, such as a computer mouse, stylus, track ball, keyboard, and/or any other device capable of receiving an input from a user.

Regarding aspects related to a communications and/or computing network, a wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, and/or the like, which may move freely, randomly or organize themselves arbitrarily, such that network topology may change, at times even rapidly. Wireless network may further employ a plurality of network access technologies, including Long Term Evolution (LTE), WLAN, Wireless Router (WR) mesh, or 2nd, 3rd, or 4th generation (2G, 3G, or 4G) cellular technology, and/or other technologies, or the like. Network access technologies may enable wide area coverage for devices, such as client devices with varying degrees of mobility, for example.

A network may enable radio frequency and/or wireless type communications via a network access technology, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or other, or the like. A wireless network may include virtually any type of now known, or to be developed, wireless communication mechanism by which signals may be communicated between devices, such as a client device or a computing device, between or within a network, or the like.

Communications between a computing device and a wireless network may be in accordance with known and/or to be developed cellular telephone communication network protocols including, for example, global system for mobile communications (GSM), enhanced data rate for GSM evolution (EDGE), and worldwide interoperability for microwave access (WiMAX). A computing device may also have a subscriber identity module (SIM) card, which, for example, may comprise a detachable smart card that stores subscription information of a user, and may also store a contact list of the user. A user may own the computing device and/or may otherwise be its primary user, for example. A computing device may be assigned an address by a wireless telephony network operator, a wired telephony network operator, and/or an Internet Service Provider (ISP). For example, an address may comprise a domestic and/or international telephone number, an Internet Protocol (IP) address, and/or one or more other identifiers. In other embodiments, a communication network may be embodied as a wired network, wireless network, or combination thereof.

A computing and/or network device may vary in terms of capabilities and/or features. Claimed subject matter is intended to cover a wide range of potential variations. For example, a network device may include a numeric keypad and/or other display of limited functionality, such as a monochrome liquid crystal display (LCD) for displaying text. In contrast, however, as another example, a web-enabled computing device may include a physical and/or a virtual keyboard, mass storage, one or more accelerometers, one or more gyroscopes, global positioning system (GPS) or other location-identifying type capability, and/or a display with a higher degree of functionality, such as a touch-sensitive color 2D or 3D display, for example.

A computing device may include and/or may execute a variety of now known, and/or to be developed operating systems, or derivatives and/or versions, including personal computer operating systems, such as a Windows, iOS or Linux, or a mobile operating system, such as iOS, Android, or Windows Mobile, or the like. A computing device may include and/or may execute a variety of possible applications, such as a client software application enabling communication with other devices, such as communicating one or more messages, such as via email, short message service (SMS), or multimedia message service (MMS), including via a network, such as a social network including, but not limited to, Facebook, LinkedIn, Twitter, Flickr, or Google+, to provide only a few examples. A computing device may also include and/or execute a software application to communicate content, such as, for example, textual content, multimedia content, or the like. A computing device may also include and/or execute a software application to perform a variety of possible tasks, such as browsing, searching, playing various forms of content, including locally stored or streamed video, or games such as, but not limited to, fantasy sports leagues. The foregoing is provided merely to illustrate that claimed subject matter is intended to include a wide range of possible features and/or capabilities.

A network including a computing device, for example, may also be extended to another device communicating as part of another network, such as via a virtual private network (VPN). To support a VPN, transmissions may be forwarded to the VPN device. For example, a software tunnel may be created. Tunneled traffic may, or may not be encrypted, and a tunneling protocol may be substantially complaint with and/or substantially compatible with any past, present or future versions of any of the following protocols: IPSec, Transport Layer Security, Datagram Transport Layer Security, Microsoft Point-to-Point Encryption, Microsoft's Secure Socket Tunneling Protocol, Multipath Virtual Private Network, Secure Shell VPN, and/or another existing protocol, and/or another protocol that may be developed.

A network may be compatible with now known, and/or to be developed, past, present, or future versions of any, but not limited to the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network may employ, for example, TCP/IP, UDP, DECnet, NetBEUI, IPX, Appletalk, other, or the like. Versions of the Internet Protocol (IP) may include IPv4, IPv6, other, and/or the like.

It will, of course, be understood that, although particular embodiments will be described, claimed subject matter is not limited in scope to a particular embodiment and/or implementation. For example, one embodiment may be in hardware, such as implemented to operate on a device or combination of devices, for example, whereas another embodiment may be, at least in part, in software. Likewise, an embodiment may be implemented in firmware, or as any combination of hardware, software, and/or firmware, for example (other than software per se). Likewise, although claimed subject matter is not limited in scope in this respect, one embodiment may comprise one or more articles, such as a storage medium or storage media. Storage media, such as, one or more CD-ROMs and/or disks, for example, may have stored thereon instructions, executable by a system, such as a computer system, computing platform, or other system, for example, that may result in an embodiment of a method in accordance with claimed subject matter being executed, such as a previously described embodiment, for example; although, of course, claimed subject matter is not limited to previously described embodiments. As one potential example, a computing platform may include one or more processing units or processors, one or more devices capable of inputting/outputting, such as a display, a keyboard and/or a mouse, and/or one or more memories, such as static random access memory, dynamic random access memory, flash memory, and/or a hard drive.

In the preceding detailed description, numerous specific details have been set forth to provide a thorough understanding of claimed subject matter. However, it will be understood by those skilled in the art that claimed subject matter may be practiced without these specific details. In other instances, methods and/or apparatuses that would be known by one of ordinary skill have not been described in detail so as not to obscure claimed subject matter. Some portions of the preceding detailed description have been presented in terms of logic, algorithms, and/or symbolic representations of operations on binary signals and/or states, such as stored within a memory of a specific apparatus or special purpose computing device or platform. In the context of this particular specification, the term specific apparatus or the like includes a general purpose computing device, such as general purpose computer, once it is programmed to perform particular functions pursuant to instructions from program software.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing information. It has proven convenient at times, principally for reasons of common usage, to refer to such signals and/or states as bits, data, values, elements, symbols, characters, terms, numbers, numerals, information, and/or the like. It should be understood, however, that all of these and/or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing device. In the context of this specification, therefore, a special purpose computer and/or a similar special purpose computing device is capable of processing, manipulating and/or transforming signals and/or states, typically represented as physical electronic and/or magnetic quantities within memories, registers, and/or other information storage devices, transmission devices, and/or display devices of the special purpose computer and/or similar special purpose computing device. In the context of this particular patent application, as mentioned, the term “specific apparatus” may include a general purpose computing device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

While there has been illustrated and/or described what are presently considered to be example features, it will be understood by those skilled in the relevant art that various other modifications may be made and/or equivalents may be substituted, without departing from claimed subject matter. Additionally, many modifications may be made to adapt a particular situation to the teachings of claimed subject matter without departing from one or more central concept(s) described herein. Therefore, it is intended that claimed subject matter not be limited to the particular examples disclosed, but that such claimed subject matter may also include all aspects falling within appended claims and/or equivalents thereof.

What is claimed is:

1. A method comprising:
forming one or more server-side mount tables for a namespace;
replicating said one or more server-side mount tables across a distributed system of platforms; and
performing no more than a single redirection responsive to a request for access to content hosted via said distributed system.

2. The method of claim 1, wherein said request for access to said content comprises a client-side request.

3. The method of claim 1, wherein said namespace comprises a hierarchy of content related parameters organized into a directory.

4. The method of claim 3, further comprising:
migrating one or more subdirectories within said namespace from a first location within said directory to a second location within said directory, said migrating being at least partially in response to load balancing of stored content related parameters among said platforms of said distributed system.

5. The method of claim 4, further comprising:
replicating said directory among said platforms across said distributed system responsive to said migrating.

6. The method of claim 3, further comprising:
detaching a subtree from a first location of said directory; and
attaching said detached subtree to a second location of said directory.

7. The method of claim 6, further comprising:
preserving platform identifiers of said stored parameters during said detaching and said attaching.

8. An article comprising:
a non-transitory storage medium comprising instructions stored thereon executable by a special purpose computing apparatus to:
generate one or more server-side mount tables for a namespace of a distributed system; and
perform no more than a single redirection responsive to a request for access to content hosted via said distributed system.

9. The article of claim 8, wherein said namespace to comprise a hierarchy of content related parameters organized into a directory.

10. The article of claim 9, wherein said instructions are further executable to:
migrate one or more subdirectories of said stored content related parameters from a first platform of said distributed system to a second platform of said distributed system, said migrating to be at least partially in response to load balancing among said platforms of said distributed system.

11. The article of claim 9, wherein said request for access to said content to comprise a client-side request.

12. The article of claim 9, wherein said instructions are further executable to:
replicate said one or more server-side mount tables among said platforms of said distributed system responsive to said migrating.

13. The article of claim 9, wherein said instructions are further executable to:
detach a subtree from a first location of said distributed system; and
attach said detached subtree to a second location of said distributed system.

14. The article of claim 13, wherein said instructions are further executable to: preserve platform identifiers of said content related parameters during said detaching and said attaching.

15. A system comprising:
a distributed set of computing devices;
the computing devices of said distributed set to redirect a request for one or more content related parameters no more than a single time from a first platform of said distributed set to a second platform of said distributed set, to replicate a directory among a plurality of platforms in said set, and to load balance storage of said content related parameters among said plurality of platforms.

16. The system of claim 15, wherein said request to originate from a client computing device.

17. The system of claim 15, wherein said directory to comprise a hierarchically organized file structure.

18. The system of claim 15, wherein at least one of said computing devices to detach and reattach a subdirectory of said directory to load balance storage from a first platform of said plurality to a second platform of said plurality.

19. The system of claim 18, wherein said at least one of said computing devices to update said directory responsive to said load balance of storage.

20. The system of claim 19, wherein said at least one of said computing devices to replicate said updated directory across said plurality of platforms.
